(19) United States
(12) Patent Application Publication
(10) Pub. No.: US 2005/0263087 A1
(43) Pub. Date: Dec. 1, 2005

(54) Pet waste disposal device

(76) Inventor: Ralph G. Livingston III, St. Clair, MI (US)

Correspondence Address: Gregory T. Zalecki, Suite 401, 12900 Hall Road, Sterling Heights, MI, 48313, US

(21) Appl. No.: 10/844,128

(22) Filed: May 12, 2004

(51) Int. Cl. A01K 29/00

(52) U.S. Cl. 119/161

(57) ABSTRACT

A pet waste disposal device is comprised of a waste bag dispenser, a carrying pouch, a panel, a belt retainer and a belt. The dispenser has a delivery slit for delivering waste bags and a releasably securable cover for retaining the bags within the dispenser. The carrying pouch holds filled waste bags. The panel connects the dispenser to the pouch such that the pouch is positioned below the dispenser a sufficient distance to permit a filled waste bag to be inserted by hand into the pouch. The belt retainer is attached to the rear side of the device. The belt is secured to the device by the belt retainer. The device is intended to be strapped onto the hip of a user. There, it provides for easy access to the waste bags and provides a receptacle for depositing filled waste bags.

### BACKGROUND

Many people have pets. Dogs are very common pets. Many dog owners and their family and friends enjoy taking their dogs for a walk. Unfortunately, sooner or later, the dog will leave dog droppings on the ground. Dog droppings are also referred to as pet waste. Both common courtesy and many laws require that pet waste be promptly removed from public and private property.

One long-standing method for removing pet waste requires the dog walker to carry one or more bags within his or her pocket. When the dog leaves droppings the person uses one of the bags to pick up the droppings. The filled bag is then carried until an appropriate disposal container, such as a garbage can, is found. The filled bag is then placed within the disposal container. This method requires the person to remember to retrieve a bag before the pet walk and also to search for and find a bag. Many people find it unappealing to carry a filled bag in their hands, in their pockets, in any other part of their clothing or within their personal accessories, such as purses.

Other devices exists which are intended to assist a pet walker in cleaning up pet waste. One such device is a scooper. It is comprised of a long handle with a scooping mechanism attached at one end. The scooping mechanism is adapted to shovel dog droppings and retain the droppings within the scooping mechanism until released. Many people find the use of a scooper undesirable. The complexity of the scooping mechanism results in a substantial manufacturing cost. The combination of the long handle and the scooping mechanism results in a somewhat large scooper which many find undesirable to carry on a pet walk. After the scooper is used, waste residue is left upon the scooping mechanism. Therefore, it needs to be cleaned after use or stored in an acceptable location. If the scooper is used in an area which is not near a disposal location, the scooper must be carried along the pet walk while the scooping mechanism contains the pet waste. Many find this undesirable because of the odor associated with the pet waste and the possibility of contaminating a person or property with pet waste while the pet waste is being carried.

There is in need for a pet waste disposal device which satisfies the following criteria. It must be simple. It must be able to be manufactured at a relatively low-cost. It must hold a number of waste disposal bags so that a person desiring to walk a pet does not need to search for bags. It must be compact so that it does not interfere with a person's walking and it is not unduly cumbersome to carry. It must facilitate the clean removal of pet waste. It must facilitate the clean transportation of pet waste. It must remain free of waste residue during normal usage.

### SUMMARY

The present invention satisfies these needs. A pet waste disposal device is comprised of a waste bag dispenser, a carrying pouch, a panel and a belt retainer. The waste bag dispenser is a container which is sized and shaped to hold a roll of waste bags. The roll of waste bags consists of a plurality of garbage bags attached together at their ends and formed into a roll. The dispenser has a slit. The leading edge of the waste bags fits through the slit. Thus the waste bags within the waste bag dispenser may be retrieved, one at a time, from outside of the waste bag dispenser through the slit.

The carrying pouch is a container which is sized and shaped to hold filled waste bags.

The panel connects the waste bag dispenser to the carrying pouch. The panel is shaped and sized such that the carrying pouch is positioned below the bag dispenser a distance sufficient to permit a filled waste bag to be inserted by hand into the carrying pouch. The panel has a front side and a rear side. The front side of the panel forms a back wall to the bag dispenser and the carrying pouch. The rear side of the panel forms a rear side of the pet waste disposal device with the bag dispenser and the carrying pouch.

The belt retainer is attached to the rear side of the pet waste disposal device. It forms a tunnel with the rear side of the pet waste disposal device. The tunnel is sized and shaped to receive and securely hold a belt.

Preferably, the waste bag dispenser, the carrying pouch, the panel and the belt retainer are formed from a cloth material. Preferably, the panel is plastically reinforced. The reinforcement maintains the shape of the waste bag dispenser and the carrying pouch. The reinforcement also maintains the spacing between the waste bag dispenser and the carrying pouch.

Preferably, the waste bag dispenser has a releasably securable cover. This allows the cover to be easily opened for the insertion of a roll of waste bags. It also allows the cover to be securely closed so that the waste bags are retained within the waste bag dispenser.

To use the pet waste disposal device a person straps a belt associated with the device around his or her waist. The belt is secured to the pet waste disposal device by the belt retainer. The belt is passed through the tunnel formed by the belt retainer. Preferably, the belt is an adjustable length belt and has mating buckles at each end. The adjustability of the belt length permits the pet waste disposal device to be used by persons of different sizes. The buckles are used to secure the pet waste disposal device to a person at or near his or her waist.

### DRAWINGS

These and other features, aspects, and advantages of the present invention will become better understood with regard to the following description, appended claims, and accompanying drawings where:

FIG. 1 is a perspective view of a pet waste disposal device secured to a user.

FIG. 2 is a perspective view of the pet waste disposal device of FIG. 1 showing the removal of a waste bag from the pet waste disposal device.

FIG. 3 is a perspective view of the pet waste disposal device of FIG. 1 showing a filled waste bag being placed within the carrying pouch of the pet waste disposal device.

FIG. 4 is a front perspective view of the pet waste disposal device of FIG. 1.

FIG. 5 is a rear perspective view of the pet waste disposal device of FIG. 1.

FIG. 6 is a front elevation view of the pet waste disposal device of FIG. 1.

FIG. 7 is a rear elevation view of the pet waste disposal device of FIG. 1.

FIG. 8 is a top plan view of the pet waste disposal device of FIG. 1.

FIG. 9 is a side elevation view of the pet waste disposal device of FIG. 1.

FIG. 10 is a side elevation view of the other side of the pet waste disposal device of FIG. 1.

FIG. 11 is a bottom plan view of the pet waste disposal device of FIG. 1.

### DESCRIPTION

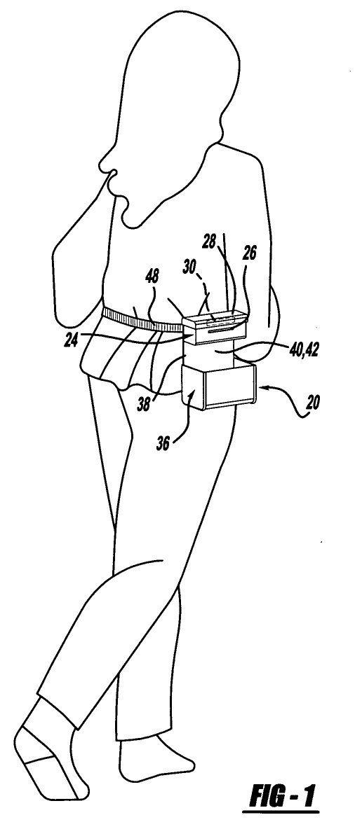

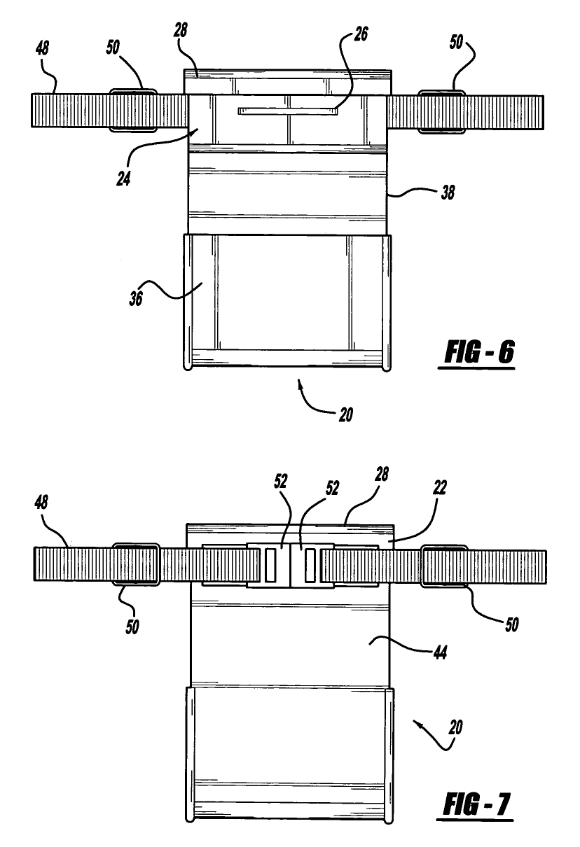

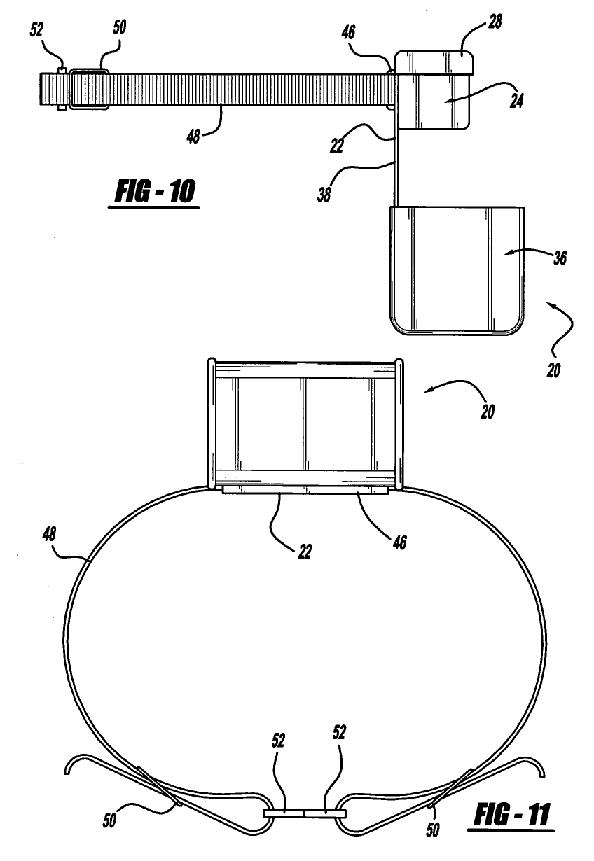

The preferred embodiment of a pet waste disposal 20 device is shown in FIG. 1 through FIG. 11. The pet waste disposal device 20 is comprised of a waste bag dispenser 24, a carrying pouch 36, a panel 38, a belt retainer 46 and a belt 48. Preferably, the waste bag dispenser 24, the carrying pouch 36, the panel 38 and the belt retainer 46 are formed from a cloth material. This will enhance the comfort to the user and permit the pet waste disposal device 20 to be compactly folded for storage. Nylon and canvas are ideal cloth materials because of their softness, durability and water resistance properties.

The waste bag dispenser 24 is a container which is sized and shaped to hold a roll of waste bags 32. The roll of waste bags 32 consists of a plurality of garbage bags attached together at their ends and formed into a roll. The waste bag dispenser 24 has a delivery slit 26 for delivering the waste bags 32 to a user. The leading-edge of the waste bags 32 fits through the delivery slit 26. Thus the waste bags 32 within the waste bag dispenser 24 may be retrieved, one at a time, from outside of the waste bag dispenser 24 through the slit 26.

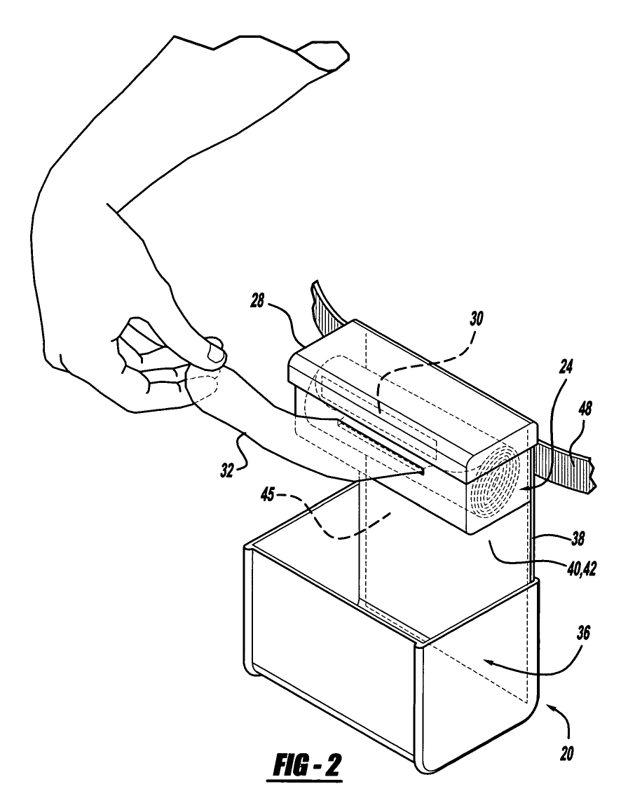

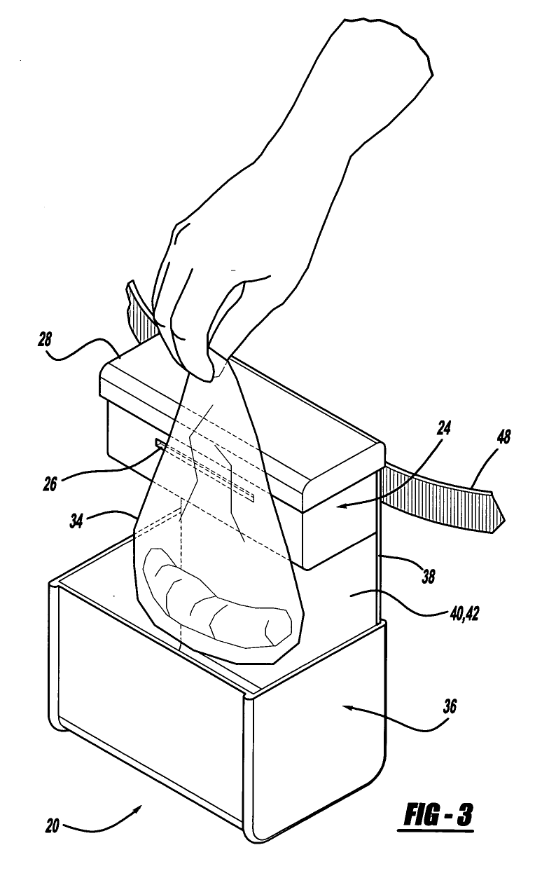

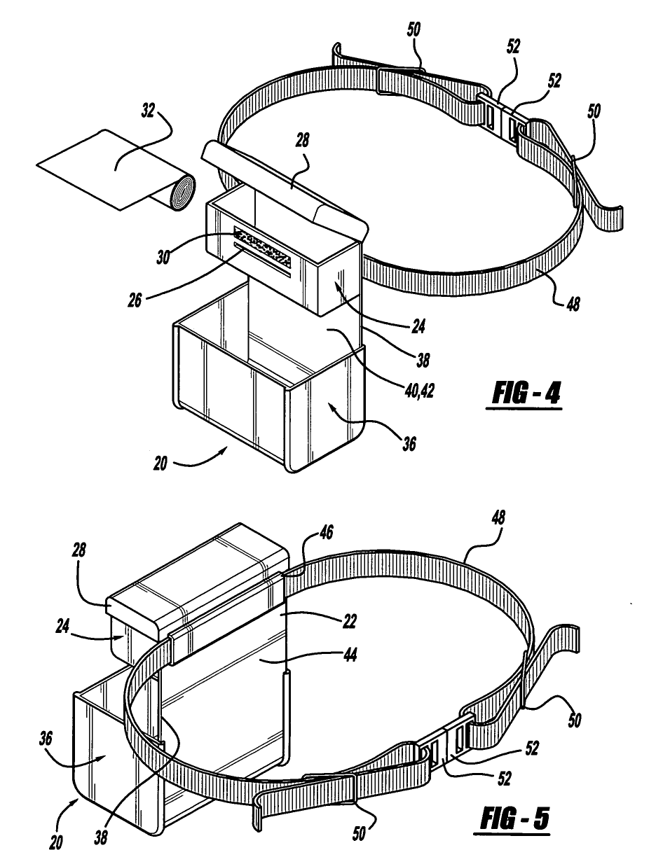

The waste bag dispenser 24 has a releasably securable cover 28. The cover 28 is in the form of a flap which may be folded in one direction to close the waste bag dispenser 24 and in another direction to open the waste bag dispenser 24. A pair of hook and loop fasteners 30 permit the cover 28 to be releasably secured to a wall of the dispenser 24. The dispenser 24 is in the shape of four vertical walls attached to a dispenser floor, as shown in FIG. 4. The cover 28 forms a top to the dispenser 24 when the cover 28 is folded into the closed position, as shown in FIG. 4 and FIG. 5. The cover 28 is hingedly attached to one of the vertical walls of the dispenser 24. One of the pair of hook and loop fasteners 30 is attached to the exterior of a wall of the dispenser 24. The wall to which the one of the pair of hook and loop fasteners 30 is attached is opposite the wall to which cover 28 is hingedly attached. The one of the pair of hook and loop fasteners 30 is centered along the upper periphery of the wall to which it is attached, near the opening formed by the four walls of the waste bag dispenser 24. The other of the pair of hook and loop fasteners 30 is positioned and attached to the cover 28 such that the cover will releasably securely close the waste bag dispenser 24 when the hook and loop fasteners 30 are connected to each other, as shown in FIG. 2.

The carrying pouch 36 is a container which is sized and shaped to hold filled waste bags 34. The carrying pouch 36 is in the form of an open top container formed by four vertical walls and a floor, as shown in FIG. 2.

The panel 38 connects the waste bag dispenser 24 to the carrying pouch 36. The panel 38 has a front side 40 and a rear side 44. The panel 38 is connected to the waste bag dispenser 24 and the carrying pouch 36 such that it forms a back wall 42 to the waste bag dispenser 24 and the carrying pouch 36, as shown in FIG. 2. The waste bag dispenser 24 and the carrying pouch 36 may each have their own independent back walls or they may have back walls formed by the panel 38. The panel 38 is shaped and sized such that the carrying pouch is positioned below the waste bag dispenser 24 a sufficient distance to permit a filled the waste bag 34 to be inserted by hand into the carrying pouch 36, as shown in FIG. 3. The rear side 44 of the panel 38 forms a rear side 22 of the pet waste disposal device 20 with the waste bag dispenser 24 and the carrying pouch 36.

Preferably, the panel 38 is plastically reinforced with a reinforcement panel 45. The reinforcement panel 45 is sized and shaped to fit within the interior of the panel 38. The preferred material for the reinforcement panel 45 is a sheet of plastic. Cardboard, or a similar stiff, but resilient, material may also be used. The reinforcement panel 45 maintains the shape of the waste bag dispenser 24 and the carrying pouch 36 by forming a stiff rear wall to the waste bag dispenser 24 and the carrying pouch 36. The reinforcement panel 45 also maintains the spacing between the waste bag dispenser 24 and the carrying pouch 36.

The belt retainer 46 is attached to the rear side 22 of the pet waste disposal device 20. The belt retainer 46 forms a tunnel with the rear side 22 of the pet waste disposal device 20, as shown in FIGS. 5, 8 and 9. The tunnel is sized and shaped to receive and securely hold the belt 48.

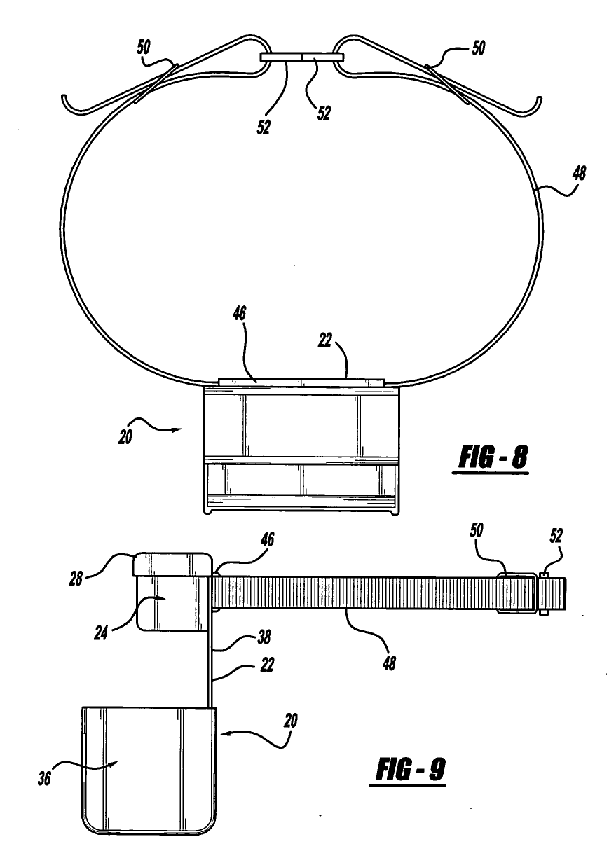

The preferred embodiment of the pet waste disposal device 20 includes the belt 48. An alternate embodiment of the pet waste disposal device 20 is as described above, but does not include the belt 48. A user using this alternate embodiment of the pet waste disposal device 20 would supply his or her own belt. The purpose of the belt 48 is to secure the pet waste disposal device 20 to the waist of a user, as shown in FIG. 1. Different users have different waist sizes. Therefore, the preferred belt is adapted with length adjusters 50, as shown in FIG. 8 and FIG. 9. The length adjusters 50 permit the belt 48 to be sized to fit the user. Each end of the belt has a mating buckle 52. The mating buckles 52 permit the ends of the belt 48 to be releasably securely attached to each other.

When a person decides to take his pet for a walk he or she first retrieves the pet waste disposal device 20. If the pet waste disposal device 20 does not hold waste bags 32, a roll of waste bags 32 is loaded into the carrying pouch 36. In order to open the cover 28, the hook and loop fasteners 30 may need to be unfastened from each other. The leading waste bag 32 is passed through the delivery slit 26 of the waste bag dispenser 24, as shown in FIG. 2. The cover 28 is releasably securely closed by fastening the hook and loop fasteners 30 together. The length of the belt 48 is adjusted to fit the user by repositioning the belt adjusters 50. The pet waste disposal device 20 is attached to the user by positioning the waste bag dispenser 24, the carrying pouch 36 and the panel 38 on the user's hip such that the opening of the carrying pouch 36 is distal to the user's body, as shown in FIG. 1. The pet waste disposal device 20 is secured to the user's body by connecting the mating buckles 52 together. The user then begins to walk the pet.

Sooner or later the pet will leave pet waste on the ground. The user will then tear off and remove a waste bag 32 from the waste bag dispenser 24. The exterior of the waste bag 32 should be placed over the user's hand and the bag 32 turned inside out so that the pet waste may be picked up with the interior of the waste bag 32. Alternatively, the pet waste may be scooped up with a scoop and placed into the waste bag 32. The filled waste bag 34 is closed and sealed. This may be accomplished by tying the open end of the waste bag 32 or by wrapping a garbage bag tie around the top of the filled waste bag 34. The filled waste bag 34 is placed within the carrying pouch 36. It is then carried to a disposal container, such as a garbage can, and there disposed. This process is repeated as necessary by using the additional waste bags 32 contained within the waste bag dispenser 24.

As can be seen from the description above the pet waste disposal device 20 is simple and can be manufactured at a relatively low-cost. It holds a plurality of waste disposal bags 32 so that a person desiring to walk a pet does not need to search for waste disposal bags 32. It is sufficiently compact so that it does not interfere with a person's walking and it is not unduly cumbersome to carry. The pet waste disposal device 20 facilitates the clean removal of pet waste. It also facilitates the clean transportation of pet waste. It remains free of waste residue during normal usage.

Although the invention has been shown and described with reference to certain preferred embodiments, those skilled in the art undoubtedly will find alternative embodiments obvious after reading this disclosure. With this in mind, the following claims are intended to define the scope of protection to be afforded the inventor, and those claims shall be deemed to include equivalent constructions insofar as they do not depart from the spirit and scope of the present invention.

1. A pet waste disposal device comprising:
(a) a waste bag dispenser having a bag delivery slit for delivering waste bags;
(b) a carrying pouch for holding a filled waste bag;
(c) a panel connecting the waste bag dispenser to the carrying pouch such that the carrying pouch is positioned below the bag dispenser a distance sufficient to permit a filled waste bag to be inserted by hand into the carrying pouch, said panel having a front side forming a back wall to the bag dispenser and carrying pouch and said panel having a rear side forming a rear side of the pet waste disposal device with the bag dispenser and the carrying pouch; and
(d) a belt retainer attached to the rear side of the pet waste disposal device.

2. The pet waste disposal device of claim 1, wherein the waste bag dispenser, the carrying pouch, the panel and the belt retainer are formed from a cloth material.

3. The pet waste disposal device of claim 2, wherein the panel is plastically reinforced for maintaining the shape of the waste bag dispenser and the carrying pouch and for maintaining the spacing between the waste bag dispenser and the carrying pouch.

4. A pet waste disposal device comprising:
(a) a waste bag dispenser having a bag delivery slit for delivering waste bags and having a releasably securable cover for retaining the bags within the dispenser;
(b) a carrying pouch for holding a filled waste bag;
(c) a panel connecting the waste bag dispenser to the carrying pouch such that the carrying pouch is positioned below the bag dispenser a distance sufficient to permit a filled waste bag to be inserted by hand into the carrying pouch, said panel having a front side forming a back wall to the bag dispenser and carrying pouch and said panel having a rear side forming a rear side of the pet waste disposal device with the bag dispenser and the carrying pouch; and
(d) a belt retainer attached to the rear side of the pet waste disposal device.

5. The pet waste disposal device of claim 4, wherein the waste bag dispenser, the carrying pouch, the panel and the belt retainer are formed from a cloth material.

6. The pet waste disposal device of claim 5, wherein the panel is plastically reinforced for maintaining the shape of the waste bag dispenser and the carrying pouch and for maintaining the spacing between the waste bag dispenser and the carrying pouch.

7. A pet waste disposal device comprising:
(a) a waste bag dispenser having a bag delivery slit for delivering waste bags and having a releasably securable cover for retaining the bags within the dispenser;
(b) a carrying pouch for holding a filled waste bag;
(c) a panel connecting the waste bag dispenser to the carrying pouch such that the carrying pouch is positioned below the bag dispenser a distance sufficient to permit a filled waste bag to be inserted by hand into the carrying pouch, said panel having a front side forming a back wall to the bag dispenser and carrying pouch and said panel having a rear side forming a rear side of the pet waste disposal device with the bag dispenser and the carrying pouch;
(d) a belt retainer attached to the rear side of the pet waste disposal device; and
(e) a belt secured to the pet waste disposal device by the belt retainer.

8. The pet waste disposal device of claim 7, wherein the waste bag dispenser, the carrying pouch, the panel and the belt retainer are formed from a cloth material.

9. The pet waste disposal device of claim 8, wherein the panel is plastically reinforced for maintaining the shape of the waste bag dispenser and the carrying pouch and for maintaining the spacing between the waste bag dispenser and the carrying pouch.

10. The pet waste disposal device of claim 7, wherein the belt is an adjustable length belt having mating buckles at each end.

11. The pet waste disposal device of claim 8, wherein the belt is an adjustable length belt having mating buckles at each end.

12. The pet waste disposal device of claim 9, wherein the belt is an adjustable length belt having mating buckles at each end.
